(19) United States
(12) Patent Application Publication
(10) Pub. No.: US 2021/0342849 A1
(43) Pub. Date: Nov. 4, 2021

(54) INFORMATION SHARING METHODS, APPARATUSES, AND DEVICES

(71) Applicant: ALIPAY (HANGZHOU) INFORMATION TECHNOLOGY CO., LTD., Hangzhou (CN)

(72) Inventors: Wenyu Yang, Hangzhou (CN); Renhui Yang, Hangzhou (CN); Yuan Chen, Hangzhou (CN); Xinmin Wang, Hangzhou (CN); Feng Qian, Hangzhou (CN); Qianting Guo, Hangzhou (CN); Shubo Li, Hangzhou (CN)

(73) Assignee: ALIPAY (HANGZHOU) INFORMATION TECHNOLOGY CO., LTD., Hangzhou (CN)

(21) Appl. No.: 17/364,328

(22) Filed: Jun. 30, 2021

(30) Foreign Application Priority Data
Aug. 31, 2020 (CN) 202010898504.5

(51) Int. Cl. G06Q 20/40; H04L 9/32; G06Q 20/38; G06Q 40/02; G06Q 10/10

(52) U.S. Cl. CPC G06Q 20/4016; H04L 9/321; G06Q 20/389; G06F 21/6245; G06Q 40/02; G06Q 10/10; G06Q 20/4014

(57) ABSTRACT

Examples in this application disclose information sharing computer-implemented methods, media, and systems. One example computer-implemented method includes receiving, from a blockchain network by a trusted execution environment (TEE), a trigger instruction based on timed starting logic, where the timed starting logic is used to determine a starting moment of a smart contract, and the timed starting logic is defined in a chain code of the blockchain network. The example method further includes combining, by the TEE, first anti-money laundering (AML) risk information and second AML risk information based on the trigger instruction to obtain a combination result, where the first AML risk information is sent by a first institution for a first user ID of a user, the second AML risk information is sent by a second institution for the user. The example method yet further includes sending, by the TEE, the combination result to the first institution.

### CROSS-REFERENCE TO RELATED APPLICATIONS

This application claims priority to Chinese Patent Application No. 202010898504.5, filed on Aug. 31, 2020, which is hereby incorporated by reference in its entirety.

### TECHNICAL FIELD

Embodiments of the present specification relate to the field of blockchain technologies, and in particular, to information sharing methods, apparatuses, and devices.

### BACKGROUND

A blockchain is a new application mode of computer technologies such as distributed data storage, point-to-point transmission, a consensus mechanism, and an encryption algorithm. A blockchain is a chained data structure obtained by combining data blocks in chronological order, and uses a cryptography method to ensure that a distributed ledger cannot be tampered with or forged. Because a blockchain has features such as de-centralization, non-tampering, and autonomy, the blockchain is attracting more attention and more widely applied.

### SUMMARY

To solve the previously-mentioned technical problem, the embodiments of the present specification are implemented as described below.

According to a first aspect, some embodiments of the present specification provide an information sharing method, where the method is applied to a privacy computing unit and includes: receiving a trigger instruction that is sent by a blockchain platform based on timed starting logic defined in a chain code; combining first AML risk information and second AML risk information based on the trigger instruction to obtain a combination result, where the first AML risk information is risk information sent by a first institution for a first user ID, the second AML risk information is risk information sent by a second institution for a second user ID, and the first user ID and the second user ID are corresponding to the same user; and sending the combination result to the first institution.

According to a second aspect, some embodiments of the present specification provide a method for starting a smart contract, where the method includes: running timed starting logic defined in a chain code; determining, based on the timed starting logic, whether a current moment reaches a timed starting moment, to obtain a first determining result; and if the first determining result is yes, sending an instruction used to start a first smart contract, where the first smart contract is used to combine first AML risk information and second AML risk information to obtain a combination result; and send the combination result to a specified address.

According to a third aspect, some embodiments of the present specification provide an information sharing apparatus, including: a trigger instruction receiving module, configured to receive a trigger instruction that is sent by a blockchain platform based on timed starting logic defined in a chain code; an information combining module, configured to combine first AML risk information and second AML risk information based on the trigger instruction to obtain a combination result, where the first AML risk information is risk information sent by a first institution for a first user ID, the second AML risk information is risk information sent by a second institution for a second user ID, and the first user ID and the second user ID are corresponding to the same user; and a first combination result sending module, configured to send the combination result to the first institution.

According to a fourth aspect, some embodiments of the present specification provide an apparatus for starting a smart contract, including: a code running module, configured to run timed starting logic defined in a chain code; a result determining module, configured to determine, based on the timed starting logic, whether a current moment reaches a timed starting moment, to obtain a first determining result; and an instruction sending module, configured to: if the first determining result is yes, send an instruction used to start a first smart contract, where the first smart contract is used to combine first AML risk information and second AML risk information to obtain a combination result; and send the combination result to a specified address.

According to a fifth invention, some embodiments of the present specification provide an information sharing device, including: at least one processor; and a memory communicatively connected to the at least one processor; where the memory stores instructions that can be executed by the at least one processor, and the instructions are executed by the at least one processor, to enable the at least one processor to: receive a trigger instruction that is sent by a blockchain platform based on timed starting logic defined in a chain code; combine first AML risk information and second AML risk information based on the trigger instruction to obtain a combination result, where the first AML risk information is risk information sent by a first institution for a first user ID, the second AML risk information is risk information sent by a second institution for a second user ID, and the first user ID and the second user ID are corresponding to the same user; and send the combination result to the first institution.

According to a sixth aspect, some embodiments of the present specification provide a device for starting a smart contract, including: at least one processor; and a memory communicatively connected to the at least one processor; where the memory stores instructions that can be executed by the at least one processor, and the instructions are executed by the at least one processor, to enable the at least one processor to: run timed starting logic defined in a chain code; determine, based on the timed starting logic, whether a current moment reaches a timed starting moment, to obtain a first determining result; and if the first determining result is yes, send an instruction used to start a first smart contract, where the first smart contract is used to combine first AML risk information and second AML risk information to obtain a combination result; and send the combination result to a specified address.

According to a seventh aspect, some embodiments of the present specification provide a computer readable medium that stores computer readable instructions, and the computer readable instructions can be executed by a processor to implement an information sharing method or a method for starting a smart contract.

Some embodiments of the present specification achieve the following beneficial effects:

By using the solutions in the previously-mentioned embodiments, an anti-money laundering obligatory institution can have more AML risk results, thereby improving a more accurate anti-money laundering audit capability of the anti-money laundering obligatory institution, and improving an overall anti-money laundering audit capability of the industry.

In addition, a blockchain node proactively starts a smart contract at a timed moment to complete a timed task, so an initiator of the timed task does not need to submit a blockchain transaction at a timed moment to the blockchain network to invoke the smart contract. On one hand, the blockchain node does not need to receive a blockchain transaction invoking the smart contract, so the blockchain node can reduce operations (for example, consensus, anti-replay check, and anti-double-spending check) of processing the blockchain transaction invoking the target smart contract, resource consumption of the blockchain node can be reduced, and efficiency of completing the timed task can be improved. On the other hand, the blockchain network automatically starts the smart contract to complete the timed task, thereby simplifying operations of the initiator of the timed task, and improving user experience.

### BRIEF DESCRIPTION OF DRAWINGS

To describe technical solutions in the embodiments of the present specification or in the existing technology more clearly, the following briefly describes the accompanying drawings required for describing the embodiments or the existing technology. Clearly, the accompanying drawings in the following description merely show some embodiments of the present specification, and a person of ordinary skill in the art can still derive other drawings from these accompanying drawings without creative efforts.

FIG. 1 is a schematic diagram illustrating a system architecture, according to some embodiments of the present specification;

FIG. 2 is a schematic flowchart illustrating an information sharing method, according to some embodiments of the present specification;

FIG. 3 is an architectural diagram of providing a verification function by using a Decentralized Identity Service (DIS) and a blockchain, according to some embodiments of the present specification;

FIG. 4 is a flowchart of providing a verification function by using a DIS and a blockchain, according to some embodiments of the present specification;

FIG. 5 is a schematic flowchart illustrating a method for starting a smart contract, according to some embodiments of the present specification;

FIG. 6 is a flowchart illustrating a method for starting an on-chain contract, according to some embodiments of the present specification;

FIG. 7 is a schematic structural diagram illustrating an information sharing apparatus corresponding to FIG. 2, according to some embodiments of the present specification; and

FIG. 8 is a schematic structural diagram illustrating an information sharing device corresponding to FIG. 2, according to some embodiments of the present specification.

### DESCRIPTION OF EMBODIMENTS

To make the objectives, technical solutions, and advantages of one or more embodiments of the present specification clearer, the following clearly and comprehensively describes the technical solutions of one or more embodiments of the present specification with reference to corresponding accompanying drawings and one or more specific embodiments of the present specification. Clearly, the described embodiments are merely some but not all of the embodiments of the present specification. All other embodiments obtained by a person of ordinary skill in the art based on the embodiments of the present specification without creative efforts shall fall within the protection scope of one or more embodiments of the present specification.

Data sharing is often required by institutions to process services. A single institution is often unable to obtain enough information to process a service, and needs to obtain information from other institutions. For example, many countries require financial institutions to provide anti-money laundering audit results in the requirements of Anti-Money Laundering (AML) compliance. At present, many national central banks and large financial institutions have tried to improve efficiency and accuracy by using blockchains in the field of anti-money laundering to satisfy regulatory requirements. Meanwhile, data (as resources) mobility and accessibility are the foundation of many data applications and industry development. However, privacy protection in data exchange and sharing is a challenge to industry development. The following still uses the previously-mentioned anti-money laundering as an example for description.

Anti-money laundering is a measure to prevent money laundering activities that cover up and conceal sources and nature of earnings from drug crimes, organized crimes of a gangdom, terrorist crimes, smuggling crimes, corruption and bribery crimes, and crimes against financial management order by using various means. Common money laundering paths involve fields such as banking, insurances, securities, and real estate. Most anti-money laundering efforts include three core aspects:

1. Customer identification system. During establishment of a service relationship or a transaction with a customer, the subject of the anti-money laundering obligation shall verify and record an identity of the customer based on an actual and valid identity card, and update the customer's identity information in time during the existence of the service relationship.

2. Large Suspicious Transaction Report (STR) system. Illegal capital flows are usually characterized by large amounts and abnormal transactions. Therefore, the STR is stipulated in laws. For the amount of transactions that reached certain standard and abnormal transactions without a legitimate purpose, financial institutions are required to report to the anti-money laundering administrative department in a timely method for the purpose of tracing illegal crimes.

3. Customer identity information and transaction record retention rules. The retention rules of customer identity information and transaction records means that financial institutions take the necessary measures to save customer identity information and transaction information for a certain period of time based on laws, so as to provide evidence for tracing illegal crimes.

The customer identity identification system, which is commonly referred to as Know Your Customer (KYC), refers to obtaining customer-related identification information, including knowing the identity of the customer when establishing a service with the customer, knowing the purpose of the transaction, knowing the source and whereabouts of the capital, knowing the long service activities and financial transactions of the customer, etc., which are the basis for anti-money laundering.

The STR system refers to a system in which a financial institution reports suspicious transactions to the central bank or the administration of foreign exchange after discovering the suspicious transactions. In addition, the financial institution is obliged to review the suspicious transactions. When a suspected crime is discovered, the financial institution needs to report it to the local police department in time. After a financial institution reviews a suspicious transaction of a user, if determining that a transaction risk of the user is high, the financial institution can label the user with a crime label in the STR. Common STR crime labels include, for example, drug crime, organized crime of a gangdom, terrorist crime, smuggling crime, corruption and bribery crime, crime against financial management order, financial fraud crime, and money-laundering crime.

All financial institutions have the obligation to review suspicious transactions. However, information about transactions related to the same user and information about the user are often different among different financial institutions. In this case, STR crime labels labeled by different financial institutions after performing suspicious transaction analysis on the same user may also be different. A better way for a financial institution to label an STR crime label to a user more accurately is to obtain an STR crime label labeled to the same user by another (or more) financial institution. Therefore, there is a need to share STR crime labels of the same user among different financial institutions.

In the previously-mentioned example, STR crime label information sharing is actually also one of AML risk information sharing. AML risk information sharing mainly refers to sharing information related to customer money-laundering risks generated and identified by anti-money laundering policies and procedures, including sharing of customer money-laundering risk level, customer STR crime type code, customer suspicious behavior information, and other information related to money-laundering risk. The following uses the STR crime type code as an example to describe an implementation process of sharing an STR crime label of the same user between different financial institutions, and implementation processes of sharing other AML risk information are similar.

For another example, a customer money-laundering risk level is used as an example. Money-laundering risk levels labeled by different financial institutions after performing suspicious transaction analysis on the same user may also be different. For example, a money-laundering risk labeled by institution A to user A is high, and a money-laundering risk labeled by institution B to user A is medium. A better way for a financial institution to label a money-laundering risk label to a user more accurately is to obtain a money-laundering risk label labeled to the same user by another (or more) financial institution. Therefore, there is a need to share money-laundering risk labels of the same user among different financial institutions.

Customer suspicious behavior information in AML risk information sharing is similar.

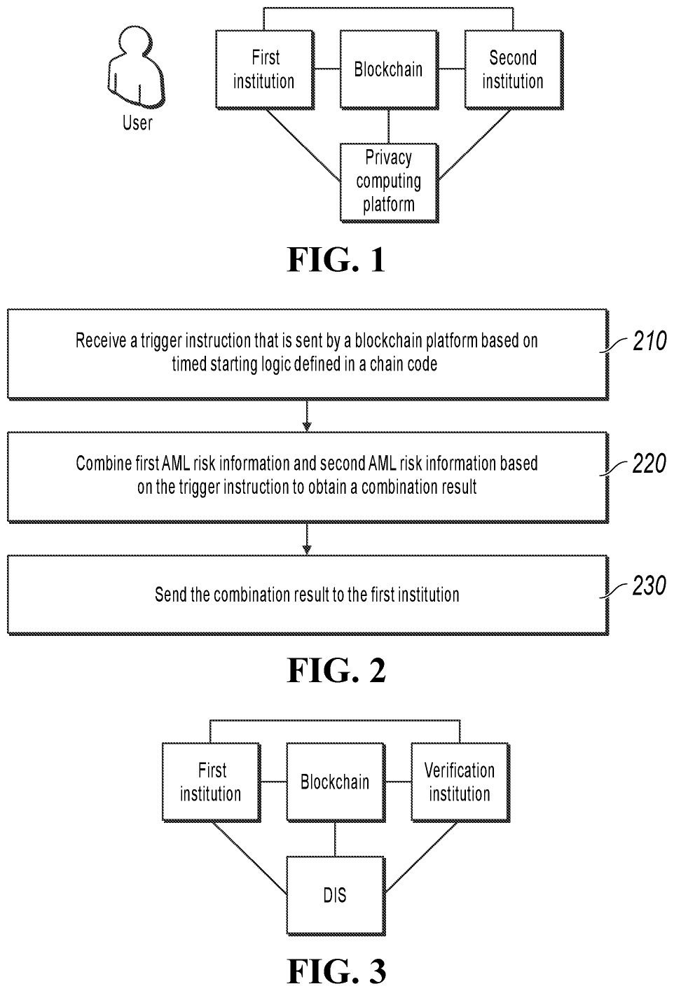

As shown in FIG. 1, an embodiment of an information sharing method provided in the present specification can include roles in FIG. 1. A first institution can directly receive user information, so as to complete certain processing work based on the user information, such as the previously-mentioned reviewing suspicious transactions. In addition, the first institution can externally provide a result of reviewing a suspicious transaction, that is, an STR crime label, or externally provide the STR crime label. Both the first institution and a second institution can be connected to a blockchain system, and can be connected to a privacy computing platform. By using the privacy computing platform, predetermined rules can be executed in a trusted security computing environment, thereby completing AML risk information sharing such as STR crime labels.

The following describes the information sharing method embodiments of the present specification with reference to the previously-mentioned examples of AML risk information sharing. That the risk information is specifically an STR crime label is used as an example. The first institution and the second institution can respectively label an STR crime label to a user based on anti-money laundering audit capabilities of the first institution and the second institution. The anti-money laundering capabilities of the first institution and the second institution may be different, and the content and quality of user information and historical transactions may also be different. In this case, the first institution and the second institution may respectively label different STR crime labels to user A. For example, the STR crime label labeled by the first institution to user A is [drug crime, organized crime of a gangdom], and the STR crime label labeled by the second institution to user A is [smuggling crime]. To obtain more accurate STR crime labels, the STR crime labels of the same user can be shared between the first institution and the second institution. That risk information is specifically a money-laundering risk level is used as an example. The first institution and the second institution can respectively label money-laundering risk levels to a user based on the anti-money laundering audit capabilities of the first institution and the second institution. Similarly, the first institution and the second institution respectively label different money-laundering risk levels to user A. For example, the money-laundering risk level label labeled by the first institution to user A is [high risk level], and the money-laundering risk level label labeled by the second institution to user A is [medium risk level]. To obtain a more accurate money-laundering risk level, the first institution and the second institution can share money-laundering risk level labels of the same user.

By using the solutions in the previously-mentioned embodiments, an anti-money laundering obligatory institution can have more AML risk results, thereby improving a more accurate anti-money laundering audit capability of the anti-money laundering obligatory institution, and improving an overall anti-money laundering audit capability of the industry.

A blockchain network is generally classified into three types: a public blockchain, a private blockchain, and a consortium blockchain. In addition, there are several types of combinations, such as private blockchain+consortium blockchain, and consortium blockchain+public blockchain. The public blockchain has the highest degree of de-centralization. The public blockchain is represented by Bitcoin and Ethereum. Participants who join the public blockchain can read on-chain data records, participate in transactions, and compete for bookkeeping rights of new blocks. Furthermore, each participant (i.e., blockchain node) can freely join and exit the network and perform related operations. On the contrary, a write access permission of the private blockchain network is controlled by a certain organization or institution, and a data reading right is specified by the organization. In short, the private blockchain can be a weak centralization system, and participating nodes are strictly limited and rare. This type of blockchain is more suitable for internal use within a specific organization. The consortium blockchain is a blockchain balanced between the public blockchain and the private blockchain, and can be “partially decentralized”. Each node in the consortium blockchain usually has a corresponding entity institution or organization. Participants join the network through authorization and form interest-related consortiums to jointly maintain blockchain operation.

In the related technologies, all of the public blockchain, the private blockchain, and the consortium blockchain may provide functions of a smart contract. The smart contract on the blockchain is a contract that can be triggered by a transaction on the blockchain system. The smart contract can be defined in the form of codes.

Taking an account model (for example, Ethereum) as an example, a blockchain account can include an external account, a contract account, etc. The external account is usually owned by a user (an individual or an institution), while the contract account corresponds to the smart contract deployed in the blockchain. The structures of various accounts are similar, and can include fields such as Balance, Nonce, Code, and Storage.

where:

the Balance field is used to maintain the current account balance;

the Nonce field is used to maintain the number of transactions of the account, and is a counter used to ensure that each transaction can be processed only once, effectively avoiding replay attacks;

the Code field is used to maintain the contract code of the account (therefore, the Code field of the external account is usually null); in practice, the Code field usually maintains only the hash value of the contract code; therefore, the Code field is also commonly referred to as a Codehash field; and

the Storage field is used to maintain the storage content of the account (the default field value is null). For the contract account, an independent storage space is usually allocated to store the content of the contract account. The independent storage space is commonly referred to as the account storage of the contract account. The storage content of the contract account usually constructs a data structure of a Merkle Patricia Trie (MPT) tree and stored in the previously-mentioned independent storage space. An MPT tree constructed based on the storage content of the contract account is usually referred to as a Storage tree. The Storage field usually maintains only the root node of the Storage tree. Therefore, the Storage field is also commonly referred to as a StorageRoot field.

An Ethereum virtual machine (EVM) is the core of Ethereum, which is a programmable blockchain, and each Ethereum node can run the EVM. The EVM is a Turing-complete virtual machine, through which various complex logics can be implemented. The user actually broadcasts and invokes the smart contract on the EVM in the Ethereum. In fact, the virtual machine directly runs a virtual machine code (virtual machine bytecode, “bytecode” for short). The smart contract has a deployment phase and an invoking phase.

In the deployment phase, the user sends a transaction that includes information about creating a smart contract to an Ethereum network. The data field of the transaction includes a code (such as a bytecode) of the smart contract. The to field of the transaction is null. Each node in the Ethereum network performs this transaction by using the EVM, and generates a corresponding contract instance. After consensus is reached between nodes by using a consensus mechanism, the smart contract corresponding to the previously-mentioned transaction is successfully created, and a contract account corresponding to the smart contract appears on the blockchain. The contract account has a specific contract address, a contract code (that is, a code of the smart contract), or a hash value of the contract code is stored in the contract account, and the contract code is used to control behavior of the corresponding smart contract.

In the invoking phase, a user (which can be the same or different from the user deploying the smart contract) sends a transaction used to invoke a smart contract to the Ethereum network, where the from field of the transaction is an address of an external account corresponding to the user, the to field is a contract address of the smart contract that needs to be invoked, and the data field includes a method and input parameter data for invoking the smart contract. After consensus is reached between the nodes by using the consensus mechanism, the smart contract invoked as declared by the above transaction is independently executed on each node of the Ethereum network in a specified method, and all execution records and data are stored in the blockchain. Therefore, after the transaction is completed, transaction records that cannot be tampered with and will not be lost are stored in the blockchain.

If the privacy computing platform completes KYC verification by running a smart control, because a smart contract on a blockchain network in the related technology is executed only when a contract invoker invokes the smart contract, that is, in the related technology, a blockchain node is triggered by using a transaction to execute the smart contract, the blockchain node cannot proactively start execution of the smart contract. However, in practice, there are various KYC verifications, and it is not possible to verify each user by using a transaction to trigger a smart contract. In addition, resources would be wasted. A better solution is to periodically verify user information of a plurality of users, for example, 10 o'clock in the morning or 10 o'clock in the evening. Therefore, a timed starting for a smart contract is needed. For example, a blockchain node in a blockchain network can proactively start a smart contract at a timed moment, so as to complete a timed task by proactively executing the smart contract at a timed moment. To this end, the purpose of the present specification is to provide a method for starting a smart contract at a timed moment through a blockchain platform to combine AML risk information to satisfy active start needs of a smart contract.

FIG. 2 is a schematic flowchart illustrating an information sharing method, according to some embodiments of the present specification. The method is applied to a privacy computing unit, where the privacy computing unit can be a node deployed on a blockchain platform, or can be a node deployed off a blockchain platform. Regardless of whether the privacy computing unit is deployed on a blockchain or off a blockchain, a smart contract in the privacy computing unit can be started by using on-chain timed starting logic.

As shown in FIG. 2, the process can include the following steps:

Step 210: Receive a trigger instruction that is sent by a blockchain platform based on timed starting logic defined in a chain code.

The timed starting logic is used to determine a starting moment of a target smart contract, and start the target smart contract when a current moment reaches the starting moment.

In some embodiments, when a blockchain network is built, a chain code of the blockchain network can be configured in a node device, so the node device runs the chain code as a blockchain node in the blockchain network. A timed starting logic can be defined in the chain code of the blockchain network in advance, so that the blockchain node can proactively start a smart contract deployed on the blockchain network, and does not need to execute the smart contract by responding to a received blockchain transaction used to invoke the smart contract. In this case, the blockchain node can complete the previously-mentioned operation of proactively starting the smart contract at a timed moment by using the timed starting logic when executing the chain code.

Specifically, the timed starting logic can be used to: determine a starting moment of the target smart contract, and start the target smart contract when the current moment reaches the starting moment. The target smart contract can be understood as a smart contract that the blockchain node can proactively start at a timed moment, and a contract code used to complete a timed task is defined in the smart contract. For example, the timed task can be an operation such as timed remittance, timed distribution of virtual rights and interests to a specified user, or a timed reminder. Taking timed transfer as an example, an account address of a blockchain account of a remitter, an account address of a blockchain account of a remittee, and a remittance amount per time can be defined in a contract code of the target smart contract. It is worthwhile to note that the target smart contract can still be deployed to the blockchain network in the previously-mentioned related technology.

It can be understood that the blockchain node proactively starts the smart contract at a timed moment to complete the timed task, so an initiator of the timed task does not need to submit a blockchain transaction at a timed moment to the blockchain network to invoke the smart contract. On one hand, the blockchain node does not need to receive a blockchain transaction invoking the smart contract, so the blockchain node can reduce operations (for example, consensus, anti-replay check, and anti-double-spending check) of processing the blockchain transaction invoking the target smart contract, resource consumption of the blockchain node can be reduced, and efficiency of completing the timed task can be improved. On the other hand, the blockchain network automatically starts the smart contract to complete the timed task, thereby simplifying operations of the initiator of the timed task and improving user experience.

In some embodiments, the blockchain node runs the chain code to determine a smart contract that needs to be proactively started at a timed moment, that is, the target smart contract.

In one case, information about the target smart contract can be recorded in the chain code, that is, the information about the target smart contract is written into the chain code when the chain code is developed. For example, a contract address of the target smart contract can be written into the chain code. Based on the information about the target smart contract recorded in the chain code, the blockchain node can determine the target smart contract by running the chain code. By recording the information about the target smart contract in the chain code, the information about the target smart contract can be effectively prevented from being maliciously tampered with.

In another case, the information about the target smart contract (there can be a plurality of target smart contracts) can be recorded in a specific predetermined blockchain account, and information about the predetermined blockchain account is recorded in the chain code, that is, the information about the predetermined blockchain account is written into the chain code when the chain code is developed. For example, the contract address of the target smart contract can be recorded in the predetermined blockchain account, and an account address of the predetermined blockchain account is written into the chain code. Based on the information about the predetermined blockchain account recorded in the chain code, the blockchain node can determine the blockchain account by running the chain code, so as to read the contract address of the target smart contract from the blockchain account. By using the previously-mentioned method of recording the target smart contract by using the blockchain account, it is convenient to update a list of smart contracts that need to be proactively started at a timed moment, so the blockchain network is controlled to complete the timed task more flexibly.

Specifically, an information update transaction that is used to update the information about the target smart contract recorded in the previously-mentioned predetermined blockchain account can be submitted to the blockchain network, where the information update transaction includes contract update information (for example, a contract address of a smart contract that needs to be proactively started a timed moment). Therefore, after receiving the information update transaction, the blockchain node in the blockchain network can update, in response to the information update transaction, the information about the target smart contract recorded in the predetermined blockchain account based on the contract update information included in the information update transaction.

In some embodiments, for a method of recording the starting moment of the target smart contract, references can also be made to the previously-mentioned method of recording the information about the target smart contract. That is, the blockchain node runs the chain code to determine the starting moment of the target smart contract. The following provides the details.

In one case, the starting moment of the target smart contract can be recorded in the chain code, that is, the starting moment of the target smart contract is written into the chain code when the chain code is developed. Based on the starting moment of the target smart contract recorded in the chain code, the blockchain node can determine the starting moment of the target smart contract by running the chain code, and then start the target smart contract when the current moment reaches the starting moment. By recording the starting moment of the target smart contract in the chain code, the starting moment of the target smart contract can be effectively prevented from being maliciously tampered with.

In another case, the starting moment can be recorded by using a specific predetermined blockchain account, and information about the predetermined blockchain account is recorded in the chain code, that is, the information about the predetermined blockchain account is written into the chain code when the chain code is developed. Based on the information about the predetermined blockchain account recorded in the chain code, the blockchain node can determine the blockchain account by running the chain code, so as to read the starting moment of the target smart contract from the blockchain account. By using the previously-mentioned method of recording the starting moment of the target smart contract by using the blockchain account, it is convenient to update the starting moment of the smart contract that needs to be proactively started at a timed moment, so the blockchain network is controlled to complete the timed task more flexibly.

Specifically, a moment update transaction used to update the starting moment recorded in the previously-mentioned predetermined blockchain account can be submitted to the blockchain network, where the moment update transaction includes moment update information (for example, content used to indicate how to update the starting moment). Therefore, after receiving the moment update transaction, the blockchain node in the blockchain network can update, in response to the moment update transaction, the starting moment of the target smart contract recorded in the predetermined blockchain account based on the contract update information included in the moment update transaction.

Further, to prevent the starting moment of the target smart contract in the blockchain account from being maliciously tampered with, permission management can be performed on an operation of the updated starting moment. For example, a proof for implementing permission management can be stored in the predetermined blockchain account. For example, the proof can be stored in the predetermined blockchain account in a form of a whitelist, a blacklist, etc. For example, an account address of an administrator of the blockchain network can be recorded in a whitelist. Then, after receiving the moment update transaction, the blockchain node can first read the account address recorded in the to field of the moment update transaction (that is, an account address of a user who submits the moment update transaction), and then determine whether the whitelist in the predetermined blockchain account records the account address; and if the whitelist in the predetermined blockchain account records the account address, the previously-mentioned update operation is further performed; otherwise, the previously-mentioned update operation is prohibited.

It is worthwhile to note that in the blockchain network, the blockchain account can include an external account, a contract account, etc. The external account is usually owned by a user (an individual or an institution), while the contract account corresponds to the smart contract deployed in the blockchain. Structures of various accounts are similar, for example, can include the Nonce field, the Balance field, the Code field, and the Storage field. The value of the Nonce field of each account starts from 0, and the value of the Nonce field increases continuously with transactions initiated by the corresponding account, so the Nonce value of each transaction initiated by the account is different, thereby avoiding replay attacks. The Balance field is used to store the balance. The Code field is used to store the code of the smart contract, so the Code field of the external account is usually null. The Storage field is used to store the content of the account. Therefore, data such as the information about the previously-mentioned target smart contract, the proof for permission management, and the starting moment can be recorded and maintained by using the external account or the contract account.

In one case, a smart contract can be pre-deployed in the blockchain network, and a contract account corresponding to the smart contract is used to record and maintain the information about the target smart contract. For example, the information about the target smart contract can be stored in the Storage field of the contract account. In another case, an external account can be created in the blockchain network to record and maintain the information about the target smart contract. For example, the information about the target smart contract can be stored in the Storage field of the external account. Certainly, the present specification does not limit the contract account and the field of the contract account to store the information about the target smart contract. For example, the information about the target smart contract can also be stored in any other field, an added field, or an improved field. This is not limited in the present specification.

It is worthwhile to note that the previously-mentioned predetermined blockchain account that records the information about the target smart contract and the predetermined blockchain account that records the starting moment can be a same blockchain account, or can be different blockchain accounts. This is not limited in the present specification.

In some embodiments, the blockchain node completes the process of proactively starting the target smart contract at a timed moment by running the timed starting logic defined in the chain code.

If the privacy computing unit is deployed on a blockchain, that is, the smart contract is deployed on a blockchain, information about the target smart contract can be directly indicated on the chain code. Therefore, when the timed starting logic defined in the chain code is run, a contract code of the target smart contract can be searched for based on the recorded information about the target smart contract, so as to execute the contract code, that is, trigger the target smart contract. If the privacy computing unit is deployed off a blockchain, the trigger instruction for running the target smart contract can be forwarded to the privacy computing unit by using the oracle mechanism.

Step 220: Combine first AML risk information and second AML risk information based on the trigger instruction to obtain a combination result, where the first AML risk information is risk information sent by a first institution for a first user ID, the second AML risk information is risk information sent by a second institution for a second user ID, and the first user ID and the second user ID are corresponding to the same user.

Related information of the first institution and the second institution is similar. The following mainly describes the first institution.

The first institution can be a financial institution, and a user can initiate a transaction through the financial institution, such as money transfer, remittance, or purchasing a financial product issued by the first institution. The first user can be an individual user, an enterprise user, etc. The first institution can perform anti-money laundering review on the first user. For example, the first institution can obtain an STR crime label or a money-laundering risk level label of the first user based on information such as basic data of the first user and a historical transactions. For an individual user, the basic data can include a part or all of information such as name, gender, nationality, certificate type, certificate number, age, occupation, mobile phone number, contact address, etc. of the individual. For an enterprise user, the basic data can include a part or all of information such as name, business license number, business place address, name of legal representative, certificate type, certificate number, validity period, etc. of the enterprise.

The first user ID can be an account registered by the user at the first institution, or an account allocated to the user by a system of the first institution when the first user initiates an operation (such as initiating money transfer or purchasing a financial product) at the first institution. Such an account can be, for example, a character string. The user ID should specifically identify a user. The corresponding field is information of the individual user or the enterprise user as described above.

For an individual user, if an identity card is uniformly used as the certificate type, the first user ID can also be an identity card number. However, the identity card number is actually also personal privacy data. Therefore, considering that personal privacy data should not be disclosed, hash processing can be performed on the identity card number. Because hash calculation has a unidirectional feature and a feature of hiding original information, and a good hash function has an anti-collision capability, that is, there is a very high probability that hash values obtained by different inputs are also different, a hash calculation result (or referred to as a digest value) can be used as a user ID. This is also the case for the mobile phone number.

Similarly, hash calculation can be performed after a group of data of a user is concatenated in order, and a digest value obtained is used as the first user ID, for example, a digest value obtained by hash(name+certificate type+certificate number) is used as a user ID, where “+” can represent sequential concatenation of characters beforehand and afterward. Anti-money laundering generally has a relatively high requirement for data security. To further strengthen data security protection, a salting operation can also be performed in hash calculation, for example, hash(name+certificate type+certificate number+salt), where salt is a value generated based on a predetermined rule.

The first institution can prompt the user to provide the basic data when the first user registers, or can request the first user to provide the basic data when the first user initiates an operation at the first institution platform.

As described above, AML risk information of the first user is, for example, an STR crime label [drug crime] [organized crime of a gangdom] labeled by the first institution to the first user, or a money-laundering risk level label [high risk level] labeled by the first institution to the first user. The first user ID corresponds to the AML risk information of the first user.

The first institution can send the first user ID and the AML risk information of the first user to the privacy computing unit. The AML risk information of the first user can be encrypted, thereby ensuring security in a data transmission process. Similarly, the first user ID can be encrypted, especially in a case that an identity card number or a mobile phone number is used as the first user ID. In addition, the first institution can sign content sent to the privacy computing unit by using a private key of the first institution. After verifying a signature by using a public key of the first institution, a recipient can acknowledge that the information is sent by the first institution, and the content is complete and is not tampered with.

The first AML risk information can be sent by the first institution to the privacy computing unit. Specifically, the first institution can send a first sharing request to the privacy computing unit, where the first sharing request includes the first user ID and the first AML risk information.

First shared data can be pre-stored in the privacy computing unit or another address, which can be an on-chain address, or can be an off-chain address. Or after obtaining the trigger instruction, the privacy computing unit can invoke a corresponding contract to obtain the first shared data from the first institution or a predetermined address. If the privacy computing unit is deployed on a blockchain, and the first shared data is stored off the blockchain, the first shared data can be obtained by using the oracle mechanism. In addition, if the privacy computing unit is deployed off the blockchain, and the first shared data is stored on the blockchain, the first shared data can also be obtained by using the oracle mechanism.

Regardless of whether the oracle mechanism is used, a second smart contract may be used to obtain the first shared data in the predetermined address.

The blockchain technology supports the user to create and invoke some complex logic in the blockchain network since Ethereum, which is one of the biggest advances of Ethereum compared with the bitcoin technology. An Ethereum virtual machine (EVM) is the core of Ethereum, which is a programmable blockchain, and each Ethereum node can run the EVM. The EVM is a Turing-complete virtual machine, through which various complex logics can be implemented. A user can deploy and invoke a smart contract by using the EVM in Ethereum. In the deployment phase, the user can send a transaction for creating a smart contract to Ethereum. The data field of the transaction can include a code (such as a bytecode) of the smart contract. The to field of the transaction is null. After diffusion and consensus of the transaction, each node in the Ethereum network can execute the transaction by using the EVM, and generate a corresponding contract instance, so as to complete deployment of the smart contract. In this case, the blockchain can have a contract account corresponding to the smart contract, and the contract account has a specific contract address. In the invoking phase, a user (which can be the same or different from the user deploying the smart contract) sends a transaction used to invoke a smart contract to the Ethereum network, where the from field of the transaction is an address of an external account corresponding to the user, the to field is a contract address of the smart contract that needs to be invoked, and the data field includes a method and a parameter for invoking the smart contract. After consensus is reached between the nodes by using the consensus mechanism, the smart contract invoked as declared by the above transaction is independently executed on each node of the Ethereum network in a specified method, and all execution records and data are stored in the blockchain. Therefore, after the transaction is completed, transaction records that cannot be tampered with and will not be lost are stored in the blockchain. With development of blockchain technologies, in addition to the EVM, many other types of virtual machines, such as WebAssembly (WASM) virtual machines, are generated.

Each blockchain node can create and invoke a smart contract by using a virtual machine. It is a challenge for privacy protection to store transactions that include smart contracts and execution results of transactions in a blockchain ledger, or to store all ledgers on each full node in the blockchain. Privacy protection can be implemented by using a plurality of technologies, such as cryptography technologies (such as homomorphic encryption or zero-knowledge proof), hardware privacy technologies, and network isolation technologies. The hardware privacy protection technologies typically includes a trusted execution environment (TEE).

For example, the blockchain nodes can implement a secure execution environment for blockchain transactions by using the TEE. The TEE is a trusted execution environment that is based on a secure extension of CPU hardware and fully isolated from the outside. Currently, the industry attaches great importance to the TEE solution. Almost all mainstream chips and software alliances have their own TEE solutions, such as a trusted platform module (TPM) in a software aspect and Intel Software Guard Extensions (SGX), ARM Trustzone, and AMD Platform Security Processor (PSP) in a hardware aspect. The TEE can function as a hardware black box. Codes and data executed in the TEE cannot be peeped even at an operating system level, and can be operated only by using an interface predefined in the codes. In terms of efficiency, because of the black box nature of the TEE, an operation in the TEE is performed on plaintext data instead of a complex cryptographic operation in homomorphic encryption, and efficiency of a calculation process is hardly lost. Therefore, by deploying the TEE environment on the blockchain node, privacy needs in the blockchain scenario can be met to a great extent while a performance loss is relatively small.

Intel SGX (SGX for short) technology is used as an example. The blockchain node can create an enclave based on the SGX technology as a TEE for executing a blockchain transaction. The blockchain node can allocate a part of Enclave Page Cache (EPC) in a memory by using a processor instruction newly added to a CPU, so as to retain the previously-mentioned enclave. A memory area corresponding to the previously-mentioned EPC is encrypted by a Memory Encryption Engine (MEE) in the CPU, content (codes and data in the enclave) in the memory area can be decrypted only in the CPU core, and keys used for encryption and decryption are generated and stored in the CPU only when the EPC starts. It can be understood that a security boundary of the enclave includes only itself and the CPU, neither privileged nor unprivileged software can access the enclave, and even an operating system administrator and a Virtual Machine Monitor (VMM, or referred to as a Hypervisor) can affect the codes and data in the enclave. Therefore, the enclave has very high security. In addition, with the previously-mentioned security guarantee, the CPU can process a blockchain transaction in a plaintext form in the enclave, and has very high operation efficiency, so both data security and calculation efficiency are ensured. Data that enters or exits the TEE can be encrypted, so as to ensure data privacy.

In some embodiments of the present specification, the blockchain node can receive the first sharing request sent by the first institution. Specifically, the first sharing request can be received by a privacy computing unit in the blockchain node. As described above, the privacy computing unit in the blockchain node can be, for example, a TEE created by the blockchain node based on the SGX technology, so as to be used for executing the blockchain transaction in a trusted and secret way. A virtual machine can be run in the TEE, so a contract is executed by using the virtual machine. As such, for an encrypted transaction for invoking a contract that is sent to the privacy computing unit of the blockchain node, the privacy computing unit can decrypt and execute the encrypted transaction in the virtual machine loaded in the privacy computing unit, and can encrypt and output an execution result. The technology for remote attestation in SGX can prove that it is legitimate SGX, and programs executed therein (e.g., virtual machine codes) are consistent with expectations. The invoked contract, as described above, can be deployed on the blockchain in advance. The deployed contract, through codes therein, can initiate an access request to data outside the blockchain during execution, or can send an execution result to another physical or logical entity outside the blockchain after execution ends. Specifically, as described below, the execution result of the smart contract can be transmitted by the TEE in the blockchain node to the first institution and the second institution by using the oracle mechanism.

Each blockchain node creates and invokes a smart contract by using a virtual machine which can consume relatively more resources. Compare to using the TEE technology to protect privacy on each node in the blockchain network, a privacy computing node (that is, an off-chain privacy computing node, also referred to as a “privacy computing unit” in some embodiments of the present disclosure) can be deployed outside the blockchain network (or referred to as “off-chain”), so computing operations that originally need to be performed on all the blockchain nodes are transferred to the off-chain privacy computing node for execution. Based on a verifiable computation technology, it can be proven that the previously-mentioned computing results are actually performed as expected in the TEE, thereby ensuring reliability while reducing on-chain resource consumption.

An off-chain TEE created on the off-chain privacy computing node is similar to the on-chain TEE created on the blockchain node, and can be a TEE implemented based on CPU hardware and fully isolated from the outside. After creating the off-chain TEE, the off-chain privacy computing node can implement a deployment operation on an off-chain contract and an operation of invoking the contract after the deployment by using the off-chain TEE, and ensure data security in the operation process.

Before being used, the privacy computing node can prove to a user that the privacy computing node is trustworthy. The process of proving itself trustworthy may involve a remote attestation report. The processes in which the on-chain and off-chain privacy computing nodes prove themselves trustworthy are similar. Using the off-chain privacy computing node as an example, a remote attestation report is generated in a remote attestation process for the off-chain TEE on the off-chain privacy computing node. The remote attestation report can be generated after an authoritative authentication server verifies self-recommendation information generated by the off-chain privacy computing node. The self-recommendation information is related to the off-chain TEE created on the off-chain privacy computing node. The off-chain privacy computing node generates the self-recommendation information related to the off-chain TEE, and after the authoritative authentication server verifies the self-recommendation information, the remote attestation report is generated, so the remote attestation report can be used to indicate that the off-chain TEE on the off-chain privacy computing node is trustworthy.

For example, before sending the first sharing request to the off-chain privacy computing unit, the first institution can first verify whether the off-chain privacy computing unit is trustworthy. Specifically, the first institution can challenge the off-chain privacy computing node, and receive the remote attestation report returned by the off-chain privacy computing node. For example, the first institution can initiate an off-chain challenge to the off-chain privacy computing node, that is, the process of initiating the challenge can be independent of the blockchain network, so a consensus process between the blockchain nodes can be skipped, and on-chain and off-chain interoperability can be reduced. Therefore, the challenge of the first institution to the off-chain privacy computing node has higher operational efficiency. For another example, the financial institution can use an on-chain challenge, for example, the financial institution can submit a challenge transaction to the blockchain node. Challenge information contained in the challenge transaction can be transmitted by the blockchain node to the off-chain privacy computing node by using the oracle mechanism, and the challenge information is used to challenge the off-chain privacy computing node. Regardless of the previously-mentioned on-chain challenge or the off-chain challenge, after obtaining the remote attestation report, a challenger (such as the financial institution) can verify a signature of the remote attestation report based on a public key of the authoritative authentication server, and if the verification succeeds, can acknowledge that the off-chain privacy computing node is trustworthy.

The off-chain privacy computing platform can store a pair of public and private keys in the TEE. The public key can be sent to a counterpart in a process such as a remote attestation process, and the private key is properly stored in the TEE. When it is determined, based on the remote attestation report, that the off-chain privacy computing node is trustworthy, the financial institution can encrypt and transmit a bytecode of the off-chain contract to the off-chain privacy computing node, and the off-chain privacy computing node obtains the bytecode through decryption in the off-chain trusted execution environment and deploys the bytecode. The previously-mentioned encryption can use the public key. In the previously-mentioned process, after a contract is deployed on the off-chain privacy computing node, the contract can be stored, and a hash value of the contract is calculated. The hash value of the contract can be fed back to the deployer of the contract. The deployer can locally generate a hash value for the deployed contract. Therefore, the deployer can compare whether a hash value of the deployed contract is the same as the local contract hash value. If they are the same, it indicates that the contract deployed on the off-chain privacy computing node is a contract deployed by the deployer. Content sent from the off-chain privacy computing node can be signed by using a private key stored in the TEE, so as to prove that the content is a result of execution by the TEE. Actually, a plurality of smart contracts can be deployed in the TEE, and the TEE can generate a separate pair of public and private keys for each smart contract. Therefore, each deployed smart contract can have an ID (for example, a public key corresponding to the smart contract or a character string generated based on the public key), and a result of execution of each smart contract can also be signed by using a private key that is properly stored in the TEE and corresponding to the smart contract. As such, it can be proved that a result is a result of execution of a specific contract in the off-chain privacy computing node. As such, execution results of different contracts can be signed by different private keys. Only a corresponding public key can verify the signature, that is, if a corresponding public key cannot verify the signature, it cannot be proved that the result is an execution result of a corresponding contract. Therefore, it is equivalent to that an identity is assigned to the contract deployed in the off-chain privacy computing node by using a pair of public and private keys. The previous description uses the off-chain privacy contract as an example. The on-chain privacy contract is similar, and can also have an identity, that is, have a pair of public and private keys.

Subsequently, the off-chain privacy computing node can invoke the deployed off-chain contract. Specifically, when the deployed off-chain contract is invoked, a bytecode of the deployed contract can be loaded and executed in the off-chain trusted execution environment, and an execution result can be fed back to an invoker of the contract, or fed back to a recipient specified in the contract or a recipient specified in a transaction for invoking the contract, or fed back to the blockchain node by using the oracle mechanism. The execution result fed back to the blockchain node by using the oracle mechanism can be further fed back to the recipient specified in the on-chain contract or to the recipient specified in the transaction for invoking the on-chain contract via the setting of the on-chain contract.

In addition, the execution result of the off-chain privacy computing node can be output after being encrypted by using a key. For example, in an asymmetric encryption method, a public key used for encryption can be a public key in a pair of public and private keys negotiated in the previously-mentioned challenge process, or can be sent by a challenger to the off-chain privacy computing node after being generated by using the DIS service. The challenger here can be the first institution in the embodiments of the present specification. Therefore, in the previously-mentioned method, it can be ensured that all data entering or exiting the off-chain privacy computing node is encrypted, so as to ensure security in a data transmission process. Similarly, data entering the off-chain privacy computing node can be signed by a sender by using a key of the sender, so as to prove, by using a signature verification process, that the data is sent by the sender, and content is complete and is not tampered with. The principles in the subsequent similar steps are the same.

Similarly, an identity can be created for the previously-mentioned challenger or the first institution by combining the DIS with the blockchain. A blockchain can provide a decentralized (or weakly centralized), non-tampering (or difficult to tamper with), trusted distributed ledger, and can provide a secure, stable, transparent, auditable, and efficient method of recording transactions and data information interaction. A blockchain network can include a plurality of nodes. Generally, one or more nodes of the blockchain belong to one participant. Generally, the more participants in a blockchain network, the more authoritative the participants are, the more trustworthy the blockchain network is. Here, a blockchain network formed by a plurality of participants is referred to as a blockchain platform. The blockchain platform can help the first institution to verify the identity.

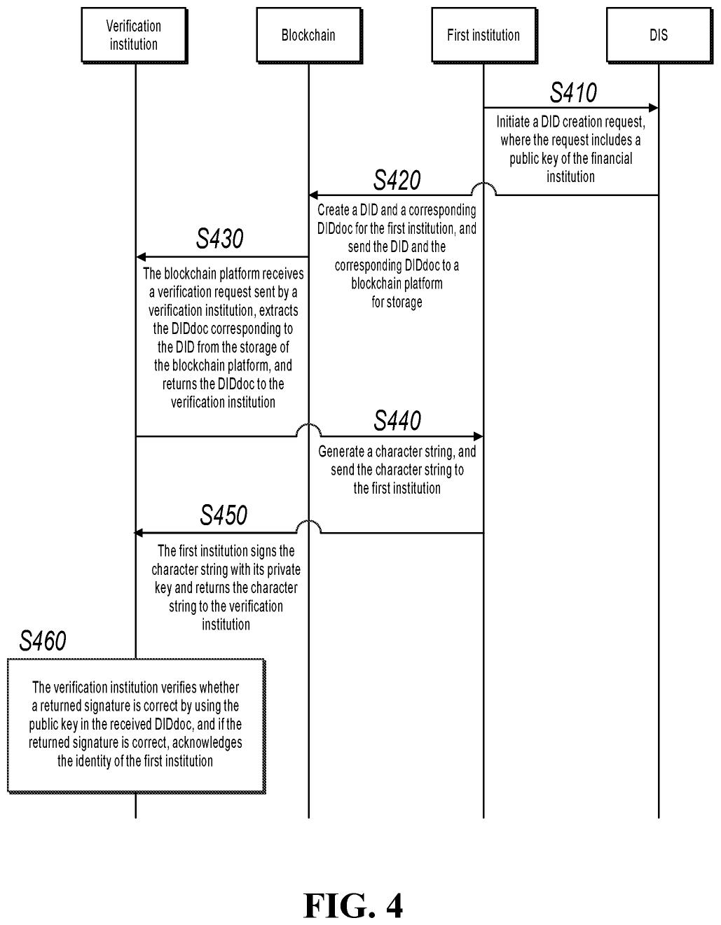

In order to use the distributed digital identity service provided by the blockchain platform, the first institution can register its identity in the blockchain platform. For example, the first institution can create a pair of public and private keys, secretly store the private key, and can create a distributed digital identity (also referred to as a decentralized identifier, DID). The first institution can create the DID by itself, or can request a decentralized identity service (DIS) system to create the DID. The DIS is a blockchain-based identity management solution that provides functions such as creating, verifying, and managing digital identities, so as to manage and protect entity data under regulation, ensure authenticity and efficiency of information flow, and solve problems such as cross-institution identity authentication and data cooperation. The DIS system can be connected to the blockchain platform. A DID can be created for the first institution by using the DIS system, the DID and the public key are sent to the blockchain platform for storage, and the created DID is further returned to the first institution. The public key can be included in DIDdoc, which can be stored in the blockchain platform. The DIS can create the DID for the first institution based on the public key sent by the first institution, for example, the DID is created after the public key of the first institution is calculated by using the hash function; or DID can be created based on other information of the first institution (which can include the public key or not include the public key). The latter case may need the first institution to provide information other than the public key. Afterward, the first institution can provide a verification function to prove to other parties that it is the first institution. For a specific example, references can be made to FIG. 3, and as shown in FIG. 4, the method includes the following steps:

S410. A first institution initiates a DID creation request to a DIS, where the request includes a public key of the first institution.

S420. In response to the creation request, the DIS creates a DID and a corresponding DIDdoc for the first institution, and sends the DID and the corresponding DIDdoc to a blockchain platform for storage, where the DIDdoc includes the public key of the first institution.

S430. A blockchain platform receives a verification request sent by a verification institution, where the verification request includes the DID of the first institution; and the blockchain platform extracts the DIDdoc corresponding to the DID from the storage of the blockchain platform, and returns the DIDdoc to the verification institution.

S440. The verification institution generates a character string, and sends the character string to the first institution.

S450. The first institution signs the character string with its private key and returns the character string to the verification institution.

S460. The verification institution verifies whether a returned signature is correct by using the public key in the previously received DIDdoc, and if the returned signature is correct, acknowledges the identity of the first institution.

The verification institution can be an on-chain node or an off-chain node on which a privacy computing unit is deployed.

A smart contract deployed on the privacy computing unit can receive the first sharing request sent by the first institution, and in addition to the first user ID and the corresponding first AML risk information, the first sharing request can further include the DID of the first institution. The first sharing request sent by the first institution can be signed by the first institution by using a private key of the first institution. Correspondingly, after receiving the sharing request, the privacy computing unit can verify the signature by using the public key of the first institution.

It is worthwhile to note that, in a case that the user ID is an account registered by the user at the institution, accounts registered by the same user at different institutions are the same. In a case that the user ID is an account allocated to the user by the system of the institution when the user initiates an operation at the institution, the account allocated to the same user by the system of the first institution and the account allocated to the same user by the system of the second institution are the same. As such, combination can be performed based on the user ID in S220.

In a case that the user ID includes a digest value obtained through hash calculation on one or more pieces of information of the user, the ID of the user in the first institution and the ID of the user in the second institution should use the same hash function and input, thereby ensuring that the ID of the same user in the first institution and the ID of the same user in the second institution are the same.

For a salting operation, the first institution and the second institution can use the same salt through negotiation in advance.

The privacy computing unit respectively receives the first sharing request and the second sharing request from the first institution and the second institution. The first sharing request includes the first user ID and corresponding first AML risk information, and the second sharing request includes the second user ID and the corresponding second AML risk information. The first AML risk information includes a first STR crime label, the second AML risk information includes a second STR crime label, and the combination result is a result of combination of the first STR crime label and the second STR crime label.

For example, the first sharing request includes {first user ID: STR crime label of the first user [drug crime] [organized crime of a gangdom] }, and the second sharing request includes {second user ID: STR crime label of the second user [smuggling crime] }. For a case that information in an incoming sharing request is encrypted, a plaintext can be obtained through decryption first.

Further, the privacy computing unit can match the first user ID against the second user ID in different sharing requests, and if the first user ID is consistent with the second user ID, combine the first AML risk information and the second AML risk information for the ID. In the previously-mentioned example, if the first user ID in the first sharing request matches the second user ID in the second sharing request, for example, is fully consistent, the privacy computing unit can combine the first AML risk information and the second AML risk information. A combination result is, for example, {first user ID/second user ID: STR crime labels of the first user/second user [drug crime] [organized crime of a gangdom][smuggling crime]}.

As described above, the first sharing request can further include a DID of the first institution. Similarly, the second sharing request can further include a DID of the second institution. Further, the privacy computing unit can match user IDs in sharing requests from different institutions, and if they are consistent, combine AML risk information for the ID. For example, the first sharing request includes {DID of the first institution: first user ID: STR crime label of the first user [drug crime] [organized crime of a gangdom]}, and the second sharing request includes {DID of the second institution: second user ID: STR crime label of the second user [smuggling crime] }. In the previously-mentioned example, if the first user ID in the first sharing request matches the second user ID in the second sharing request, for example, is fully consistent, the privacy computing unit can combine the first AML risk information and the second AML risk information. A combination result is, for example, {DID of the first institution; DID of the second institution: first user ID/second user ID: STR crime labels of the first user/second user [drug crime] [organized crime of a gangdom] [smuggling crime]}.

As described above, the privacy computing unit can be deployed with a smart contract, used to: receive the data sharing requests sent by at least two institutions, in response to the requests, match the first user ID in the first sharing request sent by the first institution against the second user ID in the second sharing request sent by the second institution, and if the first user ID is consistent with the second user ID, combine the first AML risk information in the first sharing request and the second AML risk information in the first sharing request for the ID; and further used to send combined first AML risk information and second AML risk information to the first institution and the second institution. As such, S230 and subsequent “send the combination result to the second institution” can be implemented by using the deployed smart contract.

It is worthwhile to note that the privacy computing unit can obtain a sharing request sent by the first institution for a plurality of users and a sharing request sent by the second institution for a plurality of users; can first perform matching based on the user IDs to see whether there is a same user having AML risk information in both institutions; if there is a same user having AML risk information in both institutions, perform a combination operation; and if there is a same user having AML risk information in only one institution, no combination operation is performed.

Step 230: Send the combination result to the first institution.

The privacy computing unit sends the combined first AML risk information and second AML risk information to the first institution and the second institution, that is, feeds back the combined AML risk information to the institutions that provide the AML risk information.

Further, if either one of the first institution and the second institution provides only the user ID, but does not provide any risk label, in the step of matching the first user ID against the second user ID, the privacy computing unit can first check whether the corresponding sharing request includes AML risk information, and match the first user ID against the second user ID after acknowledging that the sharing request includes the AML risk information. Further, the privacy computing unit can further check whether the existing AML risk information satisfies a predefined rule, for example, satisfies a specific label of the STR crime label. As such, after acknowledging that the AML risk information in the sharing request satisfies the predefined rule, the privacy computing unit matches the first user ID against the second user ID. If no AML risk information is included or included AML risk information does not satisfy the predefined rule, matching may not be performed, that is, the existing AML risk information is prevented from being shared with an institution that does not provide any AML risk information or provides incorrect AML risk information. Specifically, before the first AML risk information and the second AML risk information are combined, the method can further include: determining whether the first AML risk information and the second AML risk information satisfy a format requirement of an STR crime label; and if no, no combination operation on the first AML risk information and the second AML risk information is performed.

The privacy computing unit can respectively send the combined first AML risk information and second AML risk information to the first institution and the second institution respectively based on the matched and consistent DID of the first institution and DID of the second institution. The sent information can be encrypted by using a public key of a recipient, so the recipient can decrypt the received information by using a corresponding private key. Before sending the combined first AML risk information and second AML risk information to the first institution, the privacy computing unit can further first verify an identity of the first institution. For example, a process of using the previously-mentioned S410 to S460 is not described again. Similarly, before sending the combined first AML risk information and second AML risk information to the second institution, the privacy computing unit can further first verify an identity of the second institution. In addition, the privacy computing unit can send the combined first AML risk information and second AML risk information to the first institution and the second institution respectively based on the matched and consistent DID of the first institution and the DID of the second institution, and the sent information can be signed by using a private key of the privacy computing unit.

In addition, the privacy computing unit can further send a proof of the combination result to the blockchain. The proof of the combination result can include a Verifiable Claim (VC) signed by the privacy computing unit. The VC is also an important application in the DID. The VC can be stored on the blockchain platform. For example, content of the VC can include a hash value of a combination result corresponding to a user ID, and the hash value is signed by the privacy computing unit. After a process similar to S410 to S460, the privacy computing unit can store its DIDdoc on the blockchain.

When verifying the AML risk information of the institution to the user, a regulatory organization can verify the corresponding VC through the blockchain in addition to obtaining the matching result from the institution. Specifically, when obtaining the public key in the DIDdoc of the privacy computing unit from the blockchain, and verifying the combination result of the institution, the regulatory organization can further verify the signature of the VC by using the public key of the privacy computing unit, so as to acknowledge that the VC is issued by the privacy computing unit and is complete, that is, the VC is not tampered with, and the hash value is corresponding to the combination result. As such, authenticity acknowledgement of the KYC verification result provided by the financial institution can be improved based on a non-tampering feature of the blockchain platform and trustworthiness of a signing institution. The trustworthiness of the signing institution, that is, the trustworthiness of the privacy computing unit/second smart contract, can be implemented by auditing the identity of the privacy computing unit and the contract code deployed therein. The identity of the privacy computing unit is audited, for example, the previously-mentioned challenge initiation process can verify that the identity of the privacy computing unit is trustworthy.

In addition, the AML risk information of the two institutions can be combined, and also AML risk information of a plurality of institutions can be combined, and a rule for the plurality of institutions is similar to that for the two institutions. Specifically, a third sharing request sent by a third institution can be further obtained, where the third sharing request includes a third user ID, and the third user ID is corresponding to the same user as the first user ID. Whether the third sharing request includes AML risk information is determined; and if no, the combination result is not to be sent to the third institution.

As such, by using the solutions in the previously-mentioned embodiments, an anti-money laundering obligatory institution can have more AML risk results, thereby improving a more accurate anti-money laundering audit capability of the anti-money laundering obligatory institution, and improving an overall anti-money laundering audit capability of the industry.

In addition, a blockchain node proactively starts a smart contract at a timed moment to complete a timed task, so an initiator of the timed task does not need to submit a blockchain transaction at a timed moment to the blockchain network to invoke the smart contract. On one hand, the blockchain node does not need to receive a blockchain transaction invoking the smart contract, so the blockchain node can reduce operations (for example, consensus, anti-replay check, and anti-double-spending check) of processing the blockchain transaction invoking the target smart contract, resource consumption of the blockchain node can be reduced, and efficiency of completing the timed task can be improved. On the other hand, the blockchain network automatically starts the smart contract to complete the timed task, thereby simplifying operations of the initiator of the timed task and improving user experience.

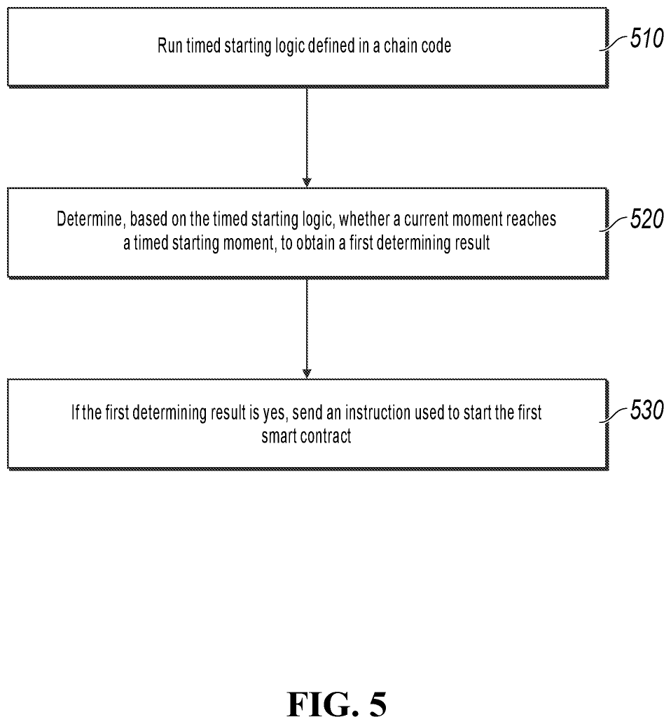

In another embodiment, a method for starting a smart contract at a timed moment by using a chain code is provided. As shown in FIG. 5, the method includes the following steps:

Step 510: Run timed starting logic defined in a chain code.

Step 520: Determine, based on the timed starting logic, whether a current moment reaches a timed starting moment, to obtain a first determining result.

Step 530: If the first determining result is yes, send an instruction used to start a first smart contract, where the first smart contract is used to combine first AML risk information and second AML risk information to obtain a combination result; and send the combination result to a specified address.

In some embodiments, when a blockchain network is built, a chain code of the blockchain network can be configured in a node device, so the node device runs the chain code as a blockchain node in the blockchain network. A timed starting logic can be defined in the chain code of the blockchain network in advance, so that the blockchain node can proactively start a smart contract deployed on the blockchain network, and does not need to execute the smart contract by responding to a received blockchain transaction used to invoke the smart contract. In this case, the blockchain node can complete the previously-mentioned operation of proactively starting the smart contract at a timed moment by using the timed starting logic when executing the chain code.

Specifically, the timed starting logic can be used to: determine a starting moment of the target smart contract, and start the target smart contract when the current moment reaches the starting moment. The target smart contract can be understood as a smart contract that the blockchain node can proactively start at a timed moment, and a contract code used to complete a timed task is defined in the smart contract. It is worthwhile to note that the target smart contract can still be deployed to the blockchain network in the previously-mentioned related technology.

It can be understood that the blockchain node proactively starts the smart contract at a timed moment to complete the timed task, so an initiator of the timed task does not need to submit a blockchain transaction at a timed moment to the blockchain network to invoke the smart contract. On one hand, the blockchain node does not need to receive a blockchain transaction invoking the smart contract, so the blockchain node can reduce operations (for example, consensus, anti-replay check, and anti-double-spending check) of processing the blockchain transaction invoking the target smart contract, resource consumption of the blockchain node can be reduced, and efficiency of completing the timed task can be improved. On the other hand, the blockchain network automatically starts the smart contract to complete the timed task, thereby simplifying operations of the initiator of the timed task and improving user experience.

In some embodiments, the blockchain node runs the chain code to determine a smart contract that needs to be proactively started at a timed moment, that is, the target smart contract.

In one case, information about the target smart contract can be recorded in the chain code, that is, the information about the target smart contract is written into the chain code when the chain code is developed. For example, a contract address of the target smart contract can be written into the chain code. Based on the information about the target smart contract recorded in the chain code, the blockchain node can determine the target smart contract by running the chain code. By recording the information about the target smart contract in the chain code, the information about the target smart contract can be effectively prevented from being maliciously tampered with.

In another case, the information about the target smart contract (there can be a plurality of target smart contracts) can be recorded in a specific predetermined blockchain account, and information about the predetermined blockchain account is recorded in the chain code, that is, the information about the predetermined blockchain account is written into the chain code when the chain code is developed. For example, the contract address of the target smart contract can be recorded in the predetermined blockchain account, and an account address of the predetermined blockchain account is written into the chain code. Based on the information about the predetermined blockchain account recorded in the chain code, the blockchain node can determine the blockchain account by running the chain code, so as to read the contract address of the target smart contract from the blockchain account. By using the previously-mentioned method of recording the target smart contract by using the blockchain account, it is convenient to update a list of smart contracts that need to be proactively started at a timed moment, so the blockchain network is controlled to complete the timed task more flexibly.

In the method of FIG. 5, the blockchain node proactively starts the smart contract at a timed moment to complete the timed task, so an initiator of the timed task does not need to submit a blockchain transaction at a timed moment to the blockchain network to invoke the smart contract. On one hand, the blockchain node does not need to receive a blockchain transaction invoking the smart contract, so the blockchain node can reduce operations (for example, consensus, anti-replay check, and anti-double-spending check) of processing the blockchain transaction invoking the target smart contract, resource consumption of the blockchain node can be reduced, and efficiency of completing the timed task can be improved. On the other hand, the blockchain network automatically starts the smart contract to complete the timed task, thereby simplifying operations of the initiator of the timed task and improving user experience.

Optionally, the sending an instruction used to start a first smart contract can specifically include:

obtaining contract information of the first smart contract;

determining, based on the contract information, whether the first smart contract is an on-chain contract, to obtain a second determining result;

if the second determining result is yes, sending an instruction used to start the first smart contract deployed on a blockchain; and

if the second determining result is no, sending an instruction for starting the first smart contract deployed on an off-chain node, where the instruction is used to invoke the first smart contract deployed on the off-chain node by using an oracle mechanism.

When whether the contract is an on-chain contract is determined, the contract code can be obtained from a predetermined block storing the first smart contract or a predetermined smart contract based on the information about the first smart contract. If the contract code is obtained, it indicates that the first smart contract is an off-chain contract.

Specifically, in the blockchain network, the blockchain account can include an external account, a contract account, etc. The external account is usually owned by a user (an individual or an institution), while the contract account corresponds to the smart contract deployed in the blockchain. Structures of various accounts are similar, for example, can include the Nonce field, the Balance field, the Code field, and the Storage field. The value of the Nonce field of each account starts from 0, and the value of the Nonce field increases continuously with transactions initiated by the corresponding account, so the Nonce value of each transaction initiated by the account is different, thereby avoiding replay attacks. The Balance field is used to store the balance. The Storage field is used to store the content of the account. The Code field is used to store the code of the smart contract, so the Code field of the external account is usually null. That is, if the code of the first smart contract cannot be found, it indicates that the first smart contract is an off-chain contract.

In some embodiments, the first smart contract can be deployed on the blockchain network, that is, belongs to an on-chain contract; or can be deployed in an off-chain node (which does not belong to the blockchain network and is an off-chain device) that is different from the blockchain node, that is, an off-chain contract. The following respectively describes processes of starting the target smart contract in the previously-mentioned two cases.

In a case that the first smart contract is an on-chain contract, after determining that the target smart contract needs to be started, the blockchain node can read the contract code of the target smart contract, so as to execute the read contract code. For the previously-mentioned process, refer to a related part of the embodiments shown in FIG. 2. Details are omitted here for simplicity.

Further, for data to be processed in a smart contract, which is different from the related technology, that is indicated by a blockchain transaction which invokes the smart contract, there is no blockchain transaction invoking the target smart contract in the process of starting the smart contract in the present specification, that is, data to be processed of the target smart contract does not need to be indicated by the blockchain transaction. In one case, the data to be processed of the target smart contract is off-chain data. Therefore, the blockchain node can obtain the off-chain data by using an oracle mechanism, so as to execute contract code to process the obtained off-chain data. In another case, the data to be processed of the target smart contract is status data of the target smart contract. Therefore, the blockchain node can obtain the status data stored in the contract account of the target smart contract, so as to execute the contract code to process the obtained status data.

In a case that the target smart contract is an off-chain contract, after determining that the first smart contract needs to be started, the blockchain node can invoke, by using the oracle mechanism, the first smart contract deployed in the off-chain node, so as to instruct the off-chain node to execute the first smart contract, and feed back, to the blockchain node by using the oracle mechanism, an execution result obtained by executing the first smart contract.

When the first smart contract that is to be started at a timed moment is used to implement relatively complex logic, because frequency of timed starting is relatively high, a process in which the blockchain node executes the contract code of the target smart contract by using a virtual machine consumes relatively more computing resources, and because all nodes in the blockchain network need to execute the contract code of the target smart contract, consumption of computing resources increases exponentially as a quantity of nodes increases. To solve the previously-mentioned problem, the first smart contract that needs to be started at a timed moment is deployed in an off-chain node, so as to avoid a case that all the blockchain nodes need to execute the contract code of the target smart contract, and the blockchain node can obtain an execution result from the off-chain node, thereby effectively reducing resource consumption on the blockchain.

Optionally, the determining whether a current moment reaches a timed starting moment can specifically include:

monitoring in real time a new block generated on a blockchain;

obtaining timestamp information of the block after the block is detected;

determining the current moment based on the timestamp information; and

determining whether the current moment reaches the timed starting moment.

As an example embodiment, a moment at which a new block is generated in the blockchain (that is, a moment at which a latest block is generated) can be used as a proof to determine whether the current moment reaches the starting moment of the first smart contract. Specifically, when a new block is generated in the blockchain, a moment at which the block is generated is recorded in a block header of the block as a timestamp. Therefore, when it is detected that a new block is generated in the blockchain, it can be determined, based on a relationship between a timestamp included in the new block and the starting moment, whether the current moment reaches the starting moment. For example, a timestamp can be read from a block header of a new block, and then the read timestamp is compared with the starting moment to determine a relationship between the read timestamp and the starting moment. For example, when the timestamp is the same as the starting moment, it is determined that the first smart contract needs to be started (it is understood that the current moment reaches the starting moment). Or when the difference between the timestamp and the starting moment falls within a predetermined duration threshold, it is determined that the target smart contract needs to be started. Certainly, a specific implementation in which the timestamp is compared with the starting moment to determine whether the current moment reaches the starting moment can be flexibly set based on an actual situation. This is not limited in the present specification. It is worthwhile to note that, the previously-mentioned logic that determines whether the current moment reaches the starting moment can be written into the chain code, for example, written into the timed starting logic of the chain code.

In some embodiments, the blockchain node can perform, by running the timed starting logic, an operation of determining whether the current moment reaches the starting moment, and can perform the operation in “real-time”. Specifically, a timer with predetermined duration can be configured, and the timed starting logic can be used to start the timer. After the timer expires, the first smart contract is started, and the timer is reset. This solution is suitable for proactively starting the first smart contract at a fixed time interval for KYC verification. For example, the timer is timed as 4 hours, 12 hours, or 24 hours. Then, the first smart contract is started every 4 hours, 12 hours, or 24 hours.

In some embodiments, the blockchain node can directly obtain time recorded by the blockchain node to determine the current moment (which is synchronized with time recorded by another blockchain node), or obtain the current moment from the network, so as to compare the determined current moment with the starting moment, so as to start the on-chain contract when the current moment reaches the starting moment.

In another embodiment, the starting moment of the first smart contract can be set based on a block height (a block number of a block). For example, a generation moment of a block with a predetermined block height is used as a starting moment, that is, when the blockchain network generates a block with the predetermined block height, it is determined that the starting moment arrives, and the target smart contract needs to be started. The predetermined block height can be specifically set to a block height of one or more specific values (for example, a block number 50 or a block number 99), or can be set to a block height that satisfies a specific condition (for example, integer multiples of 100 or integer multiples of 50). This is not limited in the present specification.

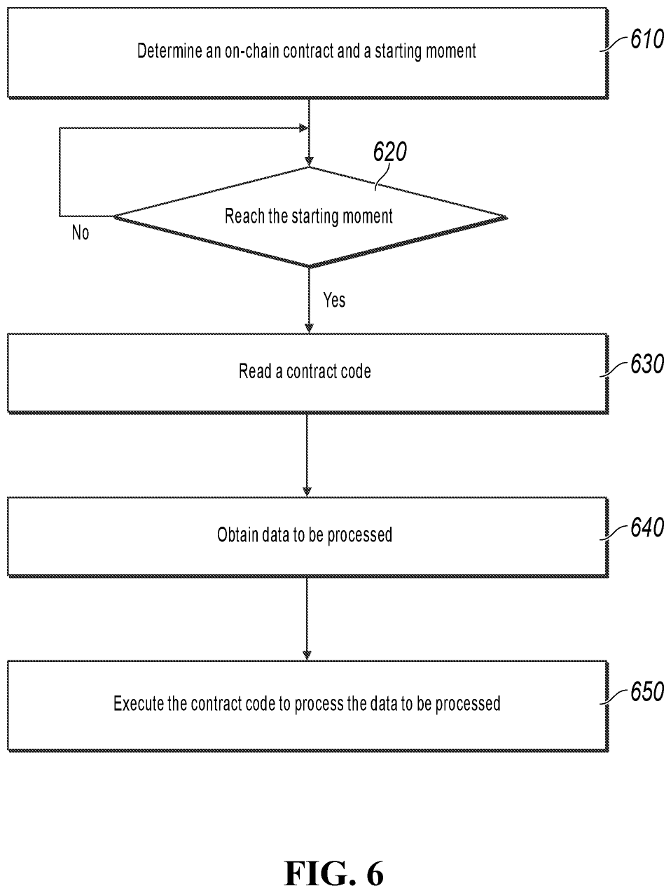

Referring to FIG. 6, FIG. 6 is a flowchart illustrating a method for starting an on-chain contract, according to some embodiments of the present specification. As shown in FIG. 6, the method is applied to a blockchain and can include the following steps:

Step 610: Determine an on-chain contract and a starting moment.

In some embodiments, for a specific implementation process of determining the on-chain contract that needs to be proactively started at a timed moment and the starting moment, references can be made to related parts of the above embodiments shown in FIG. 2 and FIG. 5, and details are omitted here for simplicity.

Step 620: Determine whether a current moment reaches the starting moment; if the current moment reaches the starting moment, perform step 630; otherwise, perform step 620.

In some embodiments, whenever a new block is generated in a blockchain, a timestamp of the new block can be used as a proof to determine whether the current moment reaches the starting moment of the on-chain contract. For example, whenever a new block is detected in the blockchain, a timestamp can be read from a block header of the new block, and then the read timestamp is compared with the starting moment to determine a relationship between the read timestamp and the starting moment. For example, when the timestamp is the same as the starting moment, it is determined that the on-chain contract needs to be started (it is understood that the current moment reaches the starting moment). Or when the difference between the timestamp and the starting moment falls within a predetermined duration threshold, it is determined that the on-chain contract needs to be started. Certainly, a specific implementation in which the timestamp is compared with the starting moment to determine whether the current moment reaches the starting moment can be flexibly set based on an actual situation. This is not limited in the present specification.

In some embodiments, the blockchain node can perform step 620 “in real time”.

Step 630: Read a contract code of the on-chain contract.

In some embodiments, because the on-chain contract is deployed in the blockchain network, the blockchain node can directly read the contract code of the on-chain contract.

Step 640: Obtain data to be processed.

Step 650: Execute the contract code to process the data to be processed.

In some embodiments, for data to be processed in a smart contract, which is different from the related technology, that is indicated by a blockchain transaction which invokes the smart contract, there is no blockchain transaction invoking the on-chain contract in the process of starting the on-chain contract in the present specification, that is, the data to be processed of the on-chain contract does not need to be indicated by the blockchain transaction. In one case, the data to be processed of the on-chain contract is off-chain data. Therefore, the blockchain node can obtain the off-chain data by using an oracle mechanism, so as to execute contract code to process the obtained off-chain data. In another case, the data to be processed of the on-chain contract is status data of the on-chain contract. Therefore, the blockchain node can obtain the status data stored in the contract account of the on-chain contract, so as to execute the contract code to process the obtained status data.

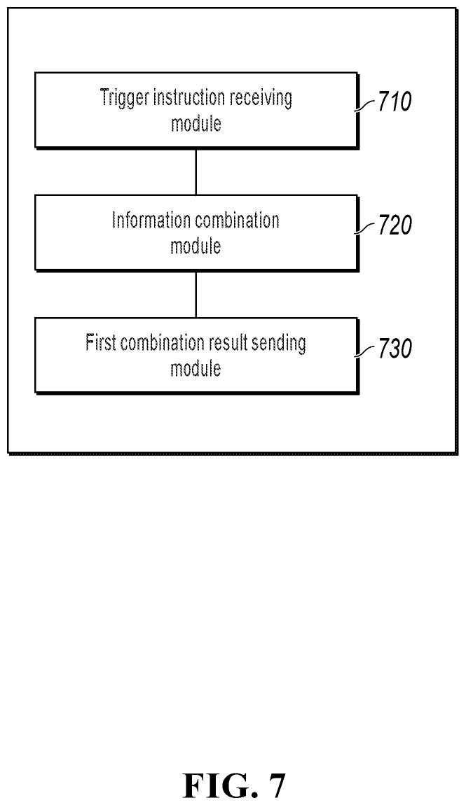

Based on the same idea, some embodiments of the present specification further provide apparatuses that correspond to the previously-mentioned method. FIG. 7 is a schematic structural diagram illustrating an information sharing apparatus corresponding to FIG. 2, according to some embodiments of the present specification. The apparatus is applied to a privacy computing unit. As shown in FIG. 7, the apparatus can include:

a trigger instruction receiving module 710, configured to receive a trigger instruction that is sent by a blockchain platform based on timed starting logic defined in a chain code;

an information combining module 720, configured to combine first AML risk information and second AML risk information based on the trigger instruction to obtain a combination result, where the first AML risk information is risk information sent by a first institution for a first user ID, the second AML risk information is risk information sent by a second institution for a second user ID, and the first user ID and the second user ID are corresponding to the same user; and

a first combination result sending module 730, configured to send the combination result to the first institution.

Based on the apparatus in FIG. 7, some embodiments of the present specification further provide some specific implementations of the apparatus, which are described below.

Optionally, the apparatus can further include a second combination result sending module, configured to send the combination result to the second institution.

Optionally, the privacy computing unit is deployed on a node on the blockchain platform, or the privacy computing unit is deployed on a node off the blockchain platform.

Optionally, the trigger instruction is sent by a node on the blockchain platform to a privacy computing unit of a node off the blockchain platform by using an oracle mechanism, and is used to start invoking a first smart contract deployed on the privacy computing unit, and the first smart contract is used to combine the first AML risk information and the second AML risk information to obtain a combination result.

Optionally, the trigger instruction is used to start invoking a first smart contract deployed on the blockchain platform, and the first smart contract is used to combine the first AML risk information and the second AML risk information to obtain a combination result.

Optionally, the first user ID includes:

an account registered by a user at the first institution; or

an account allocated to a user by a system of the first institution when the user initiates an operation at the first institution.

Similarly, the second user ID includes:

an account registered by a user at the second institution; or

an account allocated to a user by a system of the second institution when the user initiates an operation at the second institution.

Optionally, the first user ID includes a digest value obtained through hash calculation on one or more pieces of information of the same user.

Similarly, the second user ID includes a digest value obtained through hash calculation on one or more pieces of information of the same user.

Optionally, the digest value obtained through hash calculation on one or more pieces of information of the same user further includes a digest value obtained by a salting operation.

Optionally, when the privacy computing unit is deployed on a node on the blockchain platform, the apparatus further includes:

a first sharing request acquisition module, configured to obtain, by using an oracle mechanism, a first sharing request sent by the first institution, where the first sharing request includes the first user ID and the first AML risk information, and the first sharing request is stored in a node off the blockchain platform; and

a second sharing request acquisition module, configured to obtain, by using the oracle mechanism, a second sharing request sent by the second institution, where the second sharing request includes the second user ID and the second AML risk information, and the second sharing request is stored in a node off the blockchain platform.

Optionally, when the privacy computing unit is deployed on a node on the blockchain platform, the apparatus further includes:

a smart contract invoking module, configured to invoke a second smart contract to obtain a first sharing request sent by the first institution and a second sharing request sent by the second institution, where the first sharing request includes the first user ID and the first AML risk information, the second sharing request includes the second user ID and the second AML risk information, and the first sharing request and the second sharing request are stored on a node on the blockchain platform.

Optionally, the apparatus can further include:

a first determining module, configured to determine whether the first AML risk information and the second AML risk information satisfy a format requirement of an STR crime label; and if no, no combination operation on the first AML risk information and the second AML risk information is performed.

Optionally, the apparatus can further include:

a third sharing request acquisition module, configured to obtain a third sharing request sent by a third institution, where the third sharing request includes a third user ID, and the third user ID is corresponding to the same user as the first user ID; and

a second determining module, configured to determine whether the third sharing request includes AML risk information; and if no, the combination result is not sent to the third institution.

Optionally, the first AML risk information includes a first STR crime label, the second AML risk information includes a second STR crime label, and the combination result is a result of combination of the first STR crime label and the second STR crime label.

Optionally, the apparatus can further include:

an identity proving module, configured to: before the first sharing request and the second sharing request are obtained, prove an identity of the privacy computing unit to the first institution and the second institution.

Optionally, the identity proving module can be specifically configured to send a remote attestation report to the first institution and the second institution, where the remote attestation report includes self-recommendation information of the privacy computing unit about an off-chain TEE and verification information of an authority organization for the self-recommendation information.

Optionally, the apparatus can further include a first identity acknowledgement module, configured to acknowledge an identity of the first institution.

Optionally, the apparatus can further include a second identity acknowledgement module, configured to acknowledge an identity of the second institution.

Optionally, the first user ID and the second user ID are encrypted.

Optionally, the first AML risk information and the second AML risk information are encrypted.

Optionally, the apparatus can further include a combination result proof sending module, configured to send a proof of the combination result to a blockchain.

Optionally, the combination result proof sending module can be specifically configured to send the proof of the combination result to the blockchain by using the oracle mechanism.

Optionally, the proof of the combination result can include a verifiable claim signed by the privacy computing unit or the first smart contract.

Optionally, when verifying the combination result of the first institution/the second institution, a regulatory organization further verifies a signature of the verifiable claim by using a public key of the privacy computing unit or the first smart contract.

Optionally, the first sharing request further includes a decentralized identifier (DID) of the first institution, and the second sharing request further includes a DID of the second institution.

Optionally, the first combination result sending module 730 is specifically configured to send combined first AML risk information and second AML risk information to the first institution based on combined and consistent DID of the first institution and DID of the second institution.

Based on the same idea, some embodiments of the present specification further provide a schematic structural diagram illustrating an apparatus for starting a smart contract corresponding to FIG. 5. The apparatus is applied to a privacy computing unit, and the apparatus can include:

a code running module, configured to run timed starting logic defined in a chain code;

a result determining module, configured to determine, based on the timed starting logic, whether a current moment reaches a timed starting moment, to obtain a first determining result; and

an instruction sending module, configured to: if the first determining result is yes, send an instruction used to start a first smart contract, where the first smart contract is used to combine first AML risk information and second AML risk information to obtain a combination result; and send the combination result to a specified address.

Optionally, the instruction sending module can specifically include:

a contract information acquisition unit, configured to obtain contract information of the first smart contract;

a result determining unit, configured to determine, based on the contract information, whether the first smart contract is an on-chain contract, to obtain a second determining result; and

a first instruction sending determining unit, configured to: if the second determining result is yes, send an instruction used to start the first smart contract deployed on a blockchain.

Optionally, the instruction sending module can further include:

a second instruction sending unit, configured to: if the second determining result is no, send an instruction for starting the first smart contract deployed on an off-chain node, where the instruction is used to invoke the first smart contract deployed on the off-chain node by using an oracle mechanism.

Optionally, the determining whether a current moment reaches a timed starting moment can specifically include:

monitoring in real time a new block generated on a blockchain;

obtaining timestamp information of the block after the block is detected;

determining the current moment based on the timestamp information; and

determining whether the current moment reaches the timed starting moment.

Optionally, a verification result obtained after the off-chain node executes the first smart contract is fed back by the off-chain node to the blockchain by using the oracle mechanism.

Based on the same idea, some embodiments of the present specification further provide a device that corresponds to the previously-mentioned method.

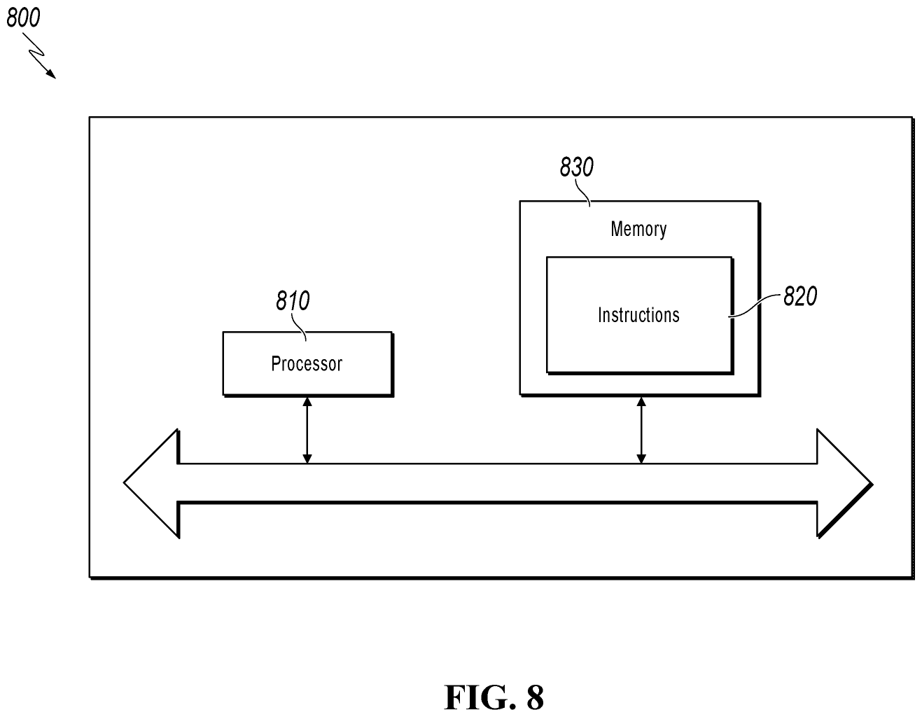

FIG. 8 is a schematic structural diagram illustrating an information sharing device corresponding to FIG. 2, according to some embodiments of the present specification. As shown in FIG. 8, the device 800 can include:

at least one processor 810; and

a memory 830 communicatively connected to the at least one processor; where

the memory 830 stores instructions 820 that can be executed by the at least one processor 810, and the instructions are executed by the at least one processor 810, to enable the at least one processor 810 to:

receive a trigger instruction that is sent by a blockchain platform based on timed starting logic defined in a chain code;

combine first AML risk information and second AML risk information based on the trigger instruction to obtain a combination result, where the first AML risk information is risk information sent by a first institution for a first user ID, the second AML risk information is risk information sent by a second institution for a second user ID, and the first user ID and the second user ID are corresponding to the same user; and

send the combination result to the first institution.

Some embodiments of the present specification provide a device for starting a smart contract, including:

at least one processor; and

a memory communicatively connected to the at least one processor; where

the memory stores instructions that can be executed by the at least one processor, and the instructions are executed by the at least one processor, to enable the at least one processor to:

run timed starting logic defined in a chain code;

determine, based on the timed starting logic, whether a current moment reaches a timed starting moment, to obtain a first determining result; and

if the first determining result is yes, send an instruction used to start a first smart contract, where the first smart contract is used to combine first AML risk information and second AML risk information to obtain a combination result; and send the combination result to a specified address.

Based on the same idea, some embodiments of the present specification further provide a computer readable medium corresponding to the previously-mentioned methods. The computer readable medium stores computer readable instructions, and the computer readable instructions can be executed by a processor to implement the following method:

receiving a trigger instruction that is sent by a blockchain platform based on timed starting logic defined in a chain code;

combining first AML risk information and second AML risk information based on the trigger instruction to obtain a combination result, where the first AML risk information is risk information sent by a first institution for a first user ID, the second AML risk information is risk information sent by a second institution for a second user ID, and the first user ID and the second user ID are corresponding to the same user; and

sending the combination result to the first institution.

Or the computer readable instructions can be executed by the processor to implement the following method:

running timed starting logic defined in a chain code;

determining, based on the timed starting logic, whether a current moment reaches a timed starting moment, to obtain a first determining result; and

if the first determining result is yes, sending an instruction used to start a first smart contract, where the first smart contract is used to combine first AML risk information and second AML risk information to obtain a combination result; and send the combination result to a specified address.

The embodiments in the present specification are described in a progressive way. For same or similar parts of the embodiments, references can be made to the embodiments. Each embodiment focuses on a difference from other embodiments.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, the programming is mostly implemented by modifying “logic compiler” software instead of manually making an integrated circuit chip. This is similar to a software compiler used for program development and compiling. However, original code before compiling is also written in a specific programming language, which is referred to as a hardware description language (HDL). There are many HDLs, such as an Advanced Boolean Expression Language (ABEL), an Altera Hardware Description Language (AHDL), Confluence, a Cornell University Programming Language (CUPL), HDCal, a Java Hardware Description Language (JHDL), Lava, Lola, MyHDL, PALASM, and a Ruby Hardware Description Language (RHDL). Currently, a Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using the previously-mentioned several described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit illustrated in the previously-mentioned embodiments can be implemented by using a computer chip or an entity, or can be implemented by using a product having a certain function. A typical implementation device is a computer. The computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the apparatus above is described by dividing functions into various units. Certainly, when the present specification is implemented, a function of each unit can be implemented in one or more pieces of software and/or hardware.

A person skilled in the art should understand that embodiments of the present disclosure can be provided as a method, a system, or a computer program product. Therefore, the present disclosure can use a form of hardware only embodiments, software only embodiments, or embodiments with a combination of software and hardware. Moreover, the present disclosure can use a form of a computer program product that is implemented on one or more computer-usable storage media (including but not limited to a disk memory, a CD-ROM, an optical memory, etc.) that include computer-usable program code.

The present disclosure is described with reference to the flowcharts and/or block diagrams of the method, the device (system), and the computer program product based on the embodiments of the present disclosure. It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer readable memory that can instruct the computer or the another programmable data processing device to work in a specific way, so the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so a series of operations and operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), one or more input/output interfaces, one or more network interfaces, and one or more memories.

The memory may include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to: a phase change memory (PRAM), a static random access memory (SRAM), a dynamic random access memory (DRAM) or another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic tape, a magnetic tape/magnetic disk memory or another magnetic storage device, or any other non-transmission medium that can be used to store information that can be accessed by a computing device. Based on the definition in the present specification, the computer readable medium does not include transitory media such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

A person skilled in the art should understand that an embodiment of the present specification can be provided as a method, a system, or a computer program product. Therefore, the present specification can use a form of hardware only embodiments, software only embodiments, or embodiments with a combination of software and hardware. In addition, the present specification can use a form of a computer program product that is implemented on one or more computer-usable storage media (including but not limited to a disk memory, a CD-ROM, an optical memory, etc.) that include computer-usable program code.

The present specification can be described in the general context of computer executable instructions executed by a computer, for example, a program module. Generally, the program module includes a routine, a program, an object, a component, a data structure, etc. executing a specific task or implementing a specific abstract data type. The present specification can also be practiced in distributed computing environments. In the distributed computing environments, tasks are performed by remote processing devices connected through a communications network. In a distributed computing environment, the program module can be located in both local and remote computer storage media including storage devices.

The previously-mentioned embodiments are embodiments of the present specification, and are not intended to limit the present specification. A person skilled in the art can make various modifications and changes to the present specification. Any modification, equivalent replacement, or improvement made without departing from the spirit and principle of the present specification shall fall within the scope of the claims in the present specification.

What is claimed is:

1. A computer-implemented method, comprising:
receiving, from a blockchain network by a trusted execution environment (TEE) in a blockchain node, a trigger instruction based on a timed starting logic, wherein the timed starting logic identifies a starting time to execute a smart contract, wherein the timed starting logic is comprised in a chain code associated with the blockchain network, and wherein the chain code comprises information of a blockchain account and is executable by the blockchain node to determine the information of the blockchain account;
combining, by the TEE, first anti-money laundering (AML) risk information and second AML risk information based on the trigger instruction to obtain a combination result, wherein the first AML risk information is sent by a first institution for a first user ID of a user, the second AML risk information is sent by a second institution for the user; and
sending, by the TEE, the combination result to the first institution.

2. The computer-implemented method of claim 1, wherein the trigger instruction is sent by a node on the blockchain network to the TEE deployed on an off-chain node outside of the blockchain network, and wherein the trigger instruction triggers a first smart contract deployed in the TEE, and the first smart contract is configured to combine the first AML risk information and the second AML risk information.

3. The computer-implemented method of claim 1, wherein the first user ID comprises an account registered by the user at the first institution or assigned to the user by the first institution in response to an operation initiated by the user at the first institution.

4. The computer-implemented method of claim 1, wherein the TEE is deployed on a blockchain node of the blockchain network, and wherein the method comprises:
obtaining, from the first institution by the TEE, a first sharing request, wherein the first sharing request comprises the first user ID and the first AML risk information, and the first sharing request is stored in an off-chain node outside of the blockchain network; and
obtaining, from the second institution by the, a second sharing request, wherein the second sharing request comprises a second user ID and the second AML risk information, and the second sharing request is stored in the off-chain node.

5. The computer-implemented method of claim 1, wherein the TEE is deployed on a blockchain node of the blockchain network, and wherein the method comprises:
invoking, by the TEE, a second smart contract to obtain a first sharing request sent by the first institution and a second sharing request sent by the second institution, wherein the first sharing request comprises the first user ID and the first AML risk information, the second sharing request comprises a second user ID and the second AML risk information, and the first sharing request and the second sharing request are stored on the blockchain node.

6. The computer-implemented method of claim 1, wherein the first AML risk information comprises a first STR crime label, the second AML risk information comprises a second STR crime label, and the combination result is a result of combination of the first STR crime label and the second STR crime label.

7. The computer-implemented method of claim 4, further comprising proving an identity of the TEE to the first institution and the second institution.

8. A non-transitory, computer-readable medium storing one or more instructions executable by a computer system to perform operations comprising:
receiving, from a blockchain network by a trusted execution environment (TEE) in a blockchain node, a trigger instruction based on a timed starting logic, wherein the timed starting logic identifies a starting time to execute a smart contract, wherein the timed starting logic is comprised in a chain code associated with the blockchain network, and wherein the chain code comprises information of a blockchain account and is executable by the blockchain node to determine the information of the blockchain account;
combining, by the TEE, first anti-money laundering (AML) risk information and second AML risk information based on the trigger instruction to obtain a combination result, wherein the first AML risk information is sent by a first institution for a first user ID of a user, the second AML risk information is sent by a second institution for the user; and
sending, by the TEE, the combination result to the first institution.

9. The non-transitory, computer-readable medium of claim 8, wherein the trigger instruction is sent by a node on the blockchain network to the TEE deployed on an off-chain node outside of the blockchain network, and wherein the trigger instruction triggers a first smart contract deployed in the TEE, and the first smart contract is configured to combine the first AML risk information and the second AML risk information.

10. The non-transitory, computer-readable medium of claim 8, wherein the first user ID comprises an account registered by the user at the first institution or assigned to the user by the first institution in response to an operation initiated by the user at the first institution.

11. The non-transitory, computer-readable medium of claim 8, wherein the TEE is deployed on a blockchain node of the blockchain network, and wherein the operations comprise:
obtaining, from the first institution by the TEE, a first sharing request, wherein the first sharing request comprises the first user ID and the first AML risk information, and the first sharing request is stored in an off-chain node outside of the blockchain network; and
obtaining, from the second institution by the, a second sharing request, wherein the second sharing request comprises a second user ID and the second AML risk information, and the second sharing request is stored in the off-chain node.

12. The non-transitory, computer-readable medium of claim 8, wherein the TEE is deployed on a blockchain node of the blockchain network, and wherein the operations comprise:
invoking, by the TEE, a second smart contract to obtain a first sharing request sent by the first institution and a second sharing request sent by the second institution, wherein the first sharing request comprises the first user ID and the first AML risk information, the second sharing request comprises a second user ID and the second AML risk information, and the first sharing request and the second sharing request are stored on the blockchain node.

13. The non-transitory, computer-readable medium of claim 8, wherein the first AML risk information comprises a first STR crime label, the second AML risk information comprises a second STR crime label, and the combination result is a result of combination of the first STR crime label and the second STR crime label.

14. The non-transitory, computer-readable medium of claim 11, wherein the operations further comprise proving an identity of the TEE to the first institution and the second institution.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, from a blockchain network by a trusted execution environment (TEE) in a blockchain node, a trigger instruction based on a timed starting logic, wherein the timed starting logic identifies a starting time to execute a smart contract, wherein the timed starting logic is comprised in a chain code associated with the blockchain network, and wherein the chain code comprises information of a blockchain account and is executable by the blockchain node to determine the information of the blockchain account;
combining, by the TEE, first anti-money laundering (AML) risk information and second AML risk information based on the trigger instruction to obtain a combination result, wherein the first AML risk information is sent by a first institution for a first user ID of a user, the second AML risk information is sent by a second institution for the user; and
sending, by the TEE, the combination result to the first institution.

16. The computer-implemented system of claim 15, wherein the trigger instruction is sent by a node on the blockchain network to the TEE deployed on an off-chain node outside of the blockchain network, and wherein the trigger instruction triggers a first smart contract deployed in the TEE, and the first smart contract is configured to combine the first AML risk information and the second AML risk information.

17. The computer-implemented system of claim 15, wherein the first user ID comprises an account registered by the user at the first institution or assigned to the user by the first institution in response to an operation initiated by the user at the first institution.

18. The computer-implemented system of claim 15, wherein the TEE is deployed on a blockchain node of the blockchain network, and wherein the operations comprise:
obtaining, from the first institution by the TEE, a first sharing request, wherein the first sharing request comprises the first user ID and the first AML risk information, and the first sharing request is stored in an off-chain node outside of the blockchain network; and
obtaining, from the second institution by the, a second sharing request, wherein the second sharing request comprises a second user ID and the second AML risk information, and the second sharing request is stored in the off-chain node.

19. The computer-implemented system of claim 15, wherein the TEE is deployed on a blockchain node of the blockchain network, and wherein the operations comprise:
invoking, by the TEE, a second smart contract to obtain a first sharing request sent by the first institution and a second sharing request sent by the second institution, wherein the first sharing request comprises the first user ID and the first AML risk information, the second sharing request comprises a second user ID and the second AML risk information, and the first sharing request and the second sharing request are stored on the blockchain node.

20. The computer-implemented system of claim 15, wherein the first AML risk information comprises a first STR crime label, the second AML risk information comprises a second STR crime label, and the combination result is a result of combination of the first STR crime label and the second STR crime label.
